(19) United States
(12) Patent Application Publication
(10) Pub. No.: US 2020/0391269 A1
(43) Pub. Date: Dec. 17, 2020

(54) SHIELD MOLDING BLANK AND SHIELD

(71) Applicant: NICHIAS CORPORATION, Tokyo (JP)

(72) Inventors: Sakae MISHINA, Tokyo (JP); Koki ENAMI, Tokyo (JP); Tadakatsu KATO, Tokyo (JP)

(21) Appl. No.: 16/962,075

(22) PCT Filed: Jul. 13, 2018
(86) PCT No.: PCT/JP2018/026562

§ 371 Date: Jul. 14, 2020

(30) Foreign Application Priority Data
Jan. 19, 2018 (JP) 2018-006944

(51) Int. Cl. B21D 13/04; B32B 15/01; B32B 3/30

(52) U.S. Cl. CPC B21D 13/045; B60R 13/0876; B32B 3/30; B32B 15/01

(57) ABSTRACT

Provided is a shield molding blank which has an uneven structure in which an air gap 4 is formed between metal plates 2, 3 formed in overlapping wavy shapes comprising recesses and projections that are periodically continuous in two directions orthogonal to each other, the shield molding blank being cut in a desired expanded shape and having peripheral edges folded. With the shield molding blank, it is possible to mold a shield having improved shield characteristics such as a heat-shielding property and a sound-shielding property.

### TECHNICAL FIELD

The present invention relates to a shield molding blank for molding a shield which covers a predetermined equipment, and more specifically, to a shield molding blank suitable for molding a shield which covers a heat and noise generator such as an exhaust manifold and a turbocharger attached to an engine, and a shield formed by processing such a shield molding blank.

### BACKGROUND ART

A shield which covers a heat and noise generator such as an exhaust manifold and a turbocharger attached to an engine is known. Such a shield is called an exhaust manifold cover, a heat insulator or the like, and is configured so as to shield transmission of heat and sound to other parts around the engine or an outside of a vehicle.

As the shield, for example, a material having two metal plates arranged with facing each other, and a filling member interposed between the metal plates which is formed of a heat-insulating material, a sound-absorbing material or the like is known (see Patent Document 1, for example). Many of the shields of this kind have an uneven structure on a surface, thereby being configured so as to improve rigidity of the shield itself and damping properties to suppress vibration of the shield itself.

Moreover, a shield in which no filling material is interposed between two metal plates is also known (see Patent Document 2, for example).

### RELATED ART DOCUMENTS

### Patent Documents

Patent Document 1: JP-A-2008-531919

Patent Document 2: JP-A-2001-507282

### SUMMARY OF THE INVENTION

### Problems to be Solved by the Invention

However, such a conventional shield has had the problems as described below.

For example. the shield described in Patent Document 1 has had a problem of a reduced storage property in an engine room because the filling member is provided between two metal plates to increase a thickness by the portion, and thus compactification is inhibited. Moreover, reduction in productivity and an increase in cost caused by use of the filling member have been regarded as a problem.

Moreover, in the shield described in Patent Document 2, while the problems as described above cannot occur because no filling member is interposed between two metal plates, shielding characteristics such as a heat-shielding property and a sound-shielding property have been liable to be reduced because two metal plates are in close contact with each other.

The present invention has been made to solve such problems, and an object of the present invention is to provide a shield molding blank for molding a shield having improved shielding characteristics such as a heat-shielding property and a sound-shielding property by providing an air gap between two metal plates, in place of the filling member, and a shield formed by processing such a shield molding blank.

### Means for Solving the Problems

A shield molding blank according to the present invention has a configuration in which the shield molding blank has an uneven structure in which an air gap is formed between two metal plates stacked and formed in overlapping wavy shapes comprising recesses and projections that are periodically continuous in two directions orthogonal to each other, and the shield molding blank is cut into a desired expanded shape and has peripheral edges folded.

Moreover, a shield according to the present invention has a configuration formed by processing the shield molding blank as described above.

### Advantageous Effects of the Invention

According to the present invention, air filled in an air gap formed between two metal plates exhibits resistance, and transmission of heat and sound is inhibited. Thus, a shield having improved shielding characteristics can be molded.

### BRIEF DESCRIPTION OF THE DRAWINGS

FIG. 1 is an explanatory diagram showing a schematic of a shield molding blank according to an embodiment of the present invention.

FIG. 2 is an explanatory diagram showing a schematic of a cross section along a direction in which wavy shapes are continuous.

FIG. 3 shows a photograph obtained by photographing a surface of metal plates 2, 3 formed in overlapping wavy shapes comprising recesses and projections that are periodically continuous in two directions orthogonal to each other.

FIG. 4 is an explanatory diagram showing a schematic of a shield formed by processing the shield molding blank according to the embodiment of the present invention.

FIG. 5 is an explanatory diagram showing a processing device for forming overlapping wavy shapes comprising recesses and projections that are periodically continuous in two directions orthogonal to each other.

FIG. 6 is an explanatory diagram showing a manner in which wavy shapes are formed by a pair of gear rolls.

FIG. 7 is an explanatory diagram showing one example of a staggered blank layout.

### MODE FOR CARRYING OUT THE INVENTION

Hereinafter, a preferable embodiment of the present invention will be described with reference to the drawings.

A shield molding blank according to the present invention is a blank material used for molding a shield which covers a heat and noise generator such as an exhaust manifold and a turbocharger attached to an engine, for example.

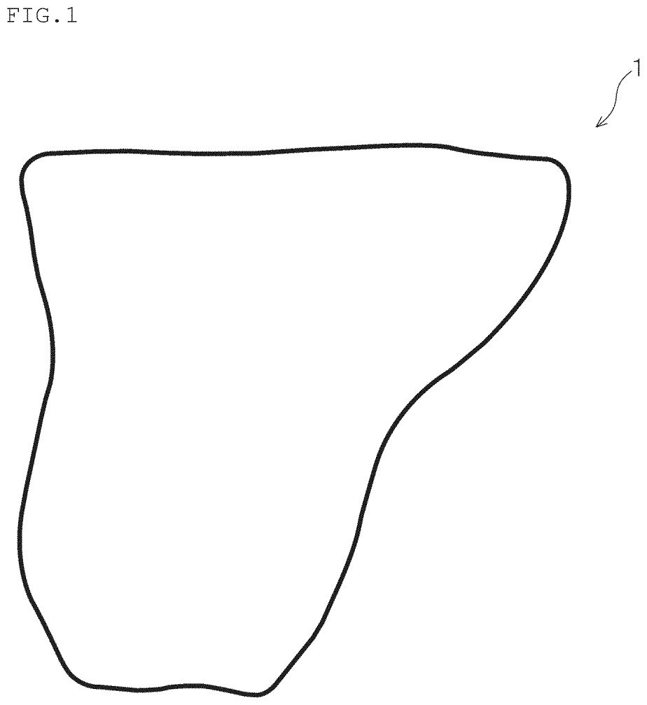

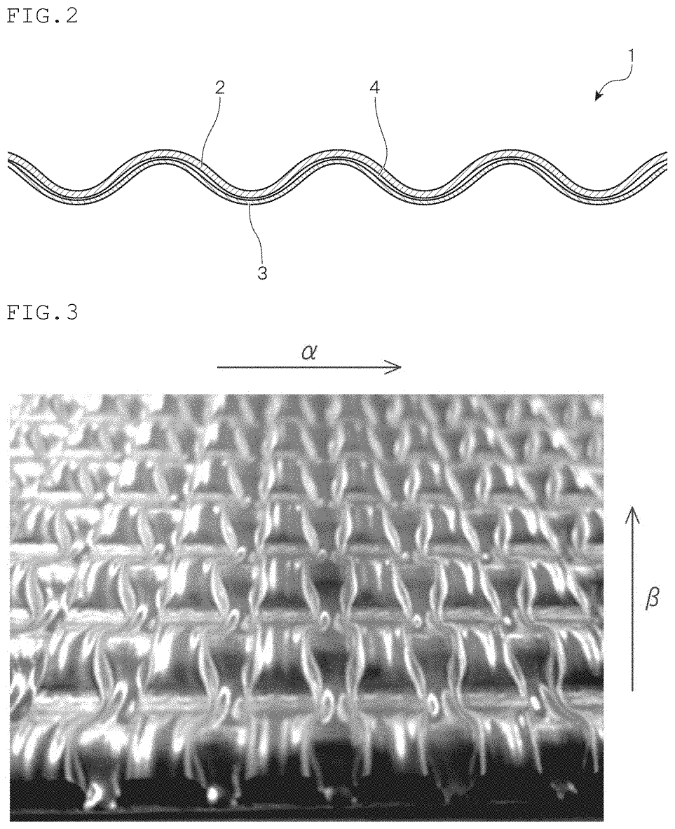

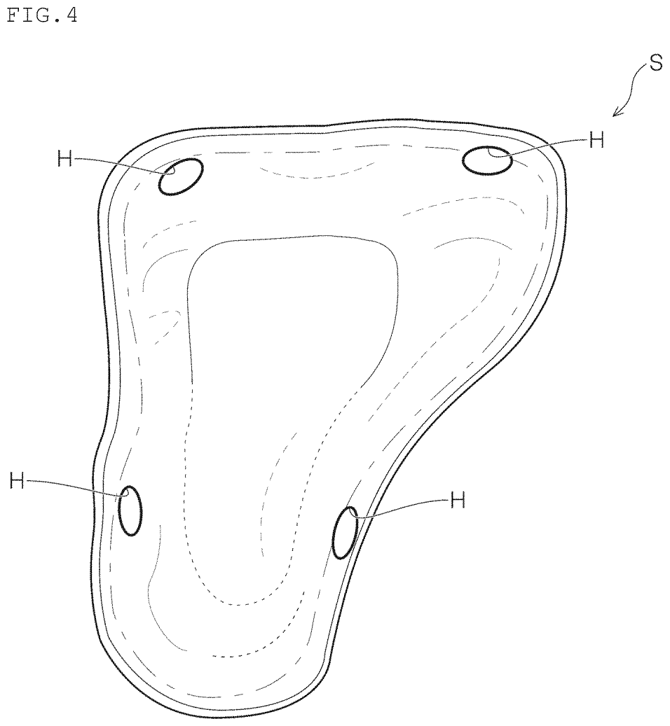

A blank 1 shown in FIG. 1 as an embodiment of the present invention has an uneven structure in which an air gap 4 is formed between two metal plates 2 and 3 stacked and formed in overlapping wavy shapes comprising recesses and projections that are periodically continuous in two directions orthogonal to each other (see FIGS. 2 and 3). Then, the blank 1 is cut into a desired expanded shape in an aligned manner so that it may be molded into a shield S shown in FIG. 4 by press molding, for example, and has peripheral edges folded.

The metal plates 2, 3 which constitute the blank 1 are a plate-shaped member formed of a metal material such as aluminum alloy and stainless steel, for example, and in each of two metal plates 2, 3, overlapping wavy shapes comprising recesses and projections that are periodically continuous in two directions orthogonal to each other are formed.

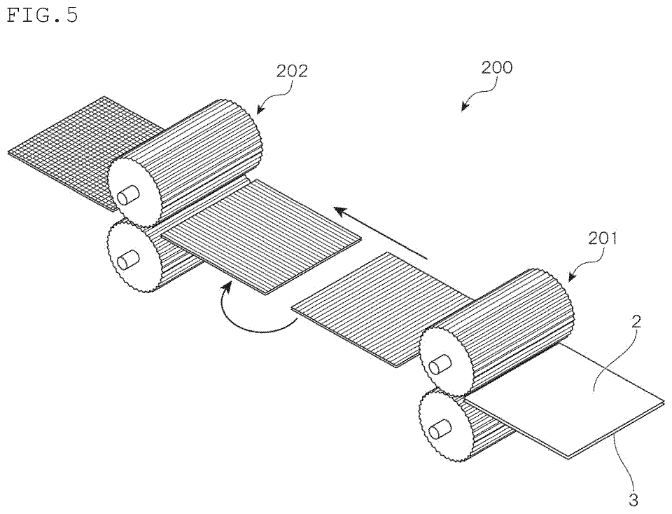

In order to form overlapping wavy shapes comprising recesses and projections that are periodically continuous in two directions orthogonal to each other in the metal plates 2, 3, a processing device 200 having two sets of wavy shape-forming rolls 201, 202 as shown in FIG. 5 is used, for example. The wavy shape-forming rolls 201, 202 each have a pair of gear rolls in which a plurality of teeth extending in parallel along an axial direction, and arranged so that a cross section orthogonal to the axial direction may be formed into a sinusoidal wavy shape are formed on each peripheral surface in the same module, and which are installed so that the mutual teeth may be meshed with play.

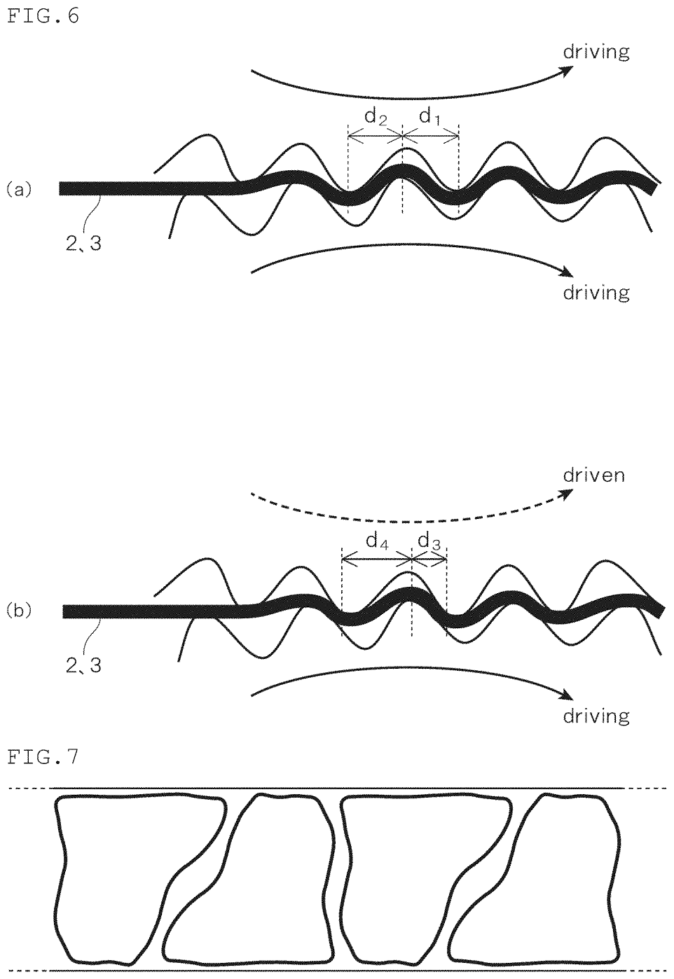

When two metal plates 2, 3 are stacked and fed between such a pair of gear rolls, the metal plates 2, 3 are deformed by the teeth arranged in one gear roll in such a manner as being pushed into a space between adjacent teeth arranged in the other gear roll. Thus, the wavy shapes (sinusoidal wavy shapes) comprising recesses and projections that are periodically continuous are formed in the metal plates 2, 3 (see FIG. 6). Accordingly, the stacked two metal plates 2, 3 are fed into a space between a pair of gear rolls which constitute a first wavy shape-forming roll 201 to form the wavy shapes comprising recesses and projections that are periodically continuous. Then, the metal plates 2, 3 are changed in directions so that ridge lines of the recesses and the projections formed by the first wavy shape-forming roll 201 may be in parallel to a feed direction, and are fed into a space between a pair of gear rolls which constitute a second wavy shape-forming roll 202. Thus, overlapping wavy shapes comprising recesses and projections that are periodically continuous in two directions orthogonal to each other can be formed (see FIGS. 2 and 3).

It should be noted that FIG. 2 is an explanatory diagram showing a schematic of a cross section along a direction in which the wavy shapes are continuous. FIG. 3 shows a photograph obtained by photographing a surface of the metal plates 2, 3 formed in overlapping wavy shapes comprising recesses and projections that are periodically continuous in two directions orthogonal to each other, in which a direction in which the wavy shapes formed by the first wavy shape-forming roll 201 are continuous is shown by an arrow α, and a direction in which the wavy shapes formed by the second wavy shape-forming roll 202 are continuous is shown by an arrow β.

In the wavy shapes formed in each of the metal plates 2, 3, the shapes can be appropriately adjusted by a shape, a pitch, a tip diameter, a root diameter, a meshing degree (a distance between a tooth tip of one gear roll and a bottom land of the other gear roll when the mutual teeth are meshed) and the like of the teeth arranged in the gear rolls. In other words, the gear rolls which constitute each of the first wavy shape-forming roll 201 and the second wavy shape-forming roll 202 are appropriately designed so that a desired wavy shape can be formed in the metal plates 2, 3.

For example, the pitch of the teeth arranged in the gear roll is designed according to a length (ordinarily, about 3 to 12 mm) of a repeating unit of the recesses and the projections which form the wavy shapes formed in the metal plates 2, 3, and the meshing degree of the teeth is designed according to a height difference (ordinarily, about 0.2 to 6.0 mm) between a top portion and a bottom portion of the recesses and the projections which form the wavy shapes formed in the metal plates 2, 3.

Although a plate thickness of the metal plates 2, 3 is ordinarily about 0.1 to about 2.0 mm, it is preferably that a degree of deformation of each of the metal plates 2, 3 is preferably made different upon forming the wavy shapes in the metal plates 2, 3 by varying a thickness of the metal plates 2, 3, or the like. Thus, the air gap 4 can be further surely formed between both the metal plates 2, 3 in a state in which the other projection portion is entered into one recess portion without causing close contact of the metal plates 2, 3 with each other.

Moreover, when overlapping wavy shapes are formed by two sets of wavy shape-forming rolls 201, 202, a difference in bending strength tends to be caused between a direction in which the wavy shapes formed by the first wavy shape-forming roll 201 are continuous and a direction in which the wavy shapes formed by the second wavy shape-forming roll 202 are continuous. In order to suppress such a difference in bending strength depending on the direction, it is preferable to appropriately adjust the meshing degree of the teeth of gear rolls of each of the first wavy shape-forming roll 201 and the second wavy shape-forming roll 202 so that the meshing degree of the teeth of the gear rolls of the second wavy shape-forming roll 202 may become smaller relative to the first wavy shape-forming roll 201, more specifically, the distance between the tooth tip of one gear roll and the bottom land of the other gear roll when the mutual teeth are meshed may be increased.

Moreover, each of two sets of wavy shape-forming rolls 201, 202 is preferably configured so that the gear rolls to be paired are synchronously driven at the same rotational speed. Thus, the recesses and the projections which form the wavy shapes formed thereon can symmetrically form the wavy shapes in such a manner that, as shown in FIG. 6(a), for example, a distance di from a top portion along the feed direction to an adjacent bottom portion on a downstream side in the feed direction may become equivalent to a distance d₂ from the top portion along the feed direction to an adjacent bottom portion on an upstream side in the feed direction.

On the other hand, if the gear rolls to be paired are configured in such a manner that one is applied as a driving roll and the other is applied as a driven roll, as shown in FIG. 6(b), for example,
a distance d₄ from a top portion along the feed direction to an adjacent bottom portion on a downstream side in the feed direction becomes longer than
a distance d₃ from the top portion along the feed direction to an adjacent bottom portion on an upstream side in the feed direction, resulting in asymmetric wavy shapes.

It should be noted that FIG. 6 is an explanatory diagram showing a manner in which the metal plates 2, 3 pass between the pair of gear rolls and the wavy shapes are formed, in which the metal plates 2, 3 are shown in a simplified manner.

The metal plates 2, 3 formed in the wavy shapes are sheared into a predetermined shape by punching processing. Forming the wavy shapes formed in the metal plates 2, 3 symmetrically has the following advantages. That is, upon punching processing, even upon adopting a staggered blank layout (multi-row layout) as shown in FIG. 7, for example, the uneven structure provided in the produced blank 1 will not differ for each layout. Thus, it is possible to form the uneven structure symmetrically with respect to a surface including the top portion or the bottom portion of the recesses and the projections and orthogonal to a direction in which the recesses and the projections are periodically continuous. Accordingly, forming the wavy shapes formed in the metal plates 2, 3 symmetrically, a yield can be improved by adopting the staggered blank layout so that scraps remaining in a surrounding may be reduced.

Further, the blank 1 is cut into the desired expanded shape in the aligned manner. Therefore, the scraps can also be significantly reduced also from unnecessity of trimming upon molding the shield S.

The metal plates 2, 3 thus punched are integrated by folding the peripheral edges so as to facilitate maneuvering. Thus, the blank 1 is completed, and when the thickness of the metal plates 2, 3 is varied, it is preferable that the metal plate 3 stacked on a back surface side is thinner-walled, as compared to the metal plate 2 stacked on a front surface side, and the blank 1 has the peripheral edges folded onto the back surface side.

The blank 1 thus produced is processed into a product through a plurality of steps such as a molding step of molding the blank 1 into a shape with which the heat and noise generator can be covered, and a perforation step of forming a mounting hole H for mounting a coupling for attaching the blank 1 to the heat and noise generator.

In the molding step, the blank 1 is set to a pair of male and female press molding molds, and the blank 1 is pressed in the molds to three-dimensionally mold the blank 1 into the shield S having a solid shape shown in FIG. 4. On the occasion, a mold structure of the press molding mold can be appropriately designed so as to prevent loss of the air gap 4 formed between the metal plates 2 and 3.

In the shield S thus processed, the air gap 4 is formed between two metal plates 2 and 3, and thus transmission of heat and sound is inhibited by air filled in the air gap 4. Thus, heat-shielding characteristics and sound-shielding characteristics are improved. One of the metal plates 2, 3 is thin-walled, which can effectively contribute to weight reduction and also cost reduction.

In the perforation step, the mounting hole H is perforated at a predetermined hole diameter according to the coupling to be mounted. As the coupling, for example, the coupling proposed by the present applicant and described hereinabove in JP-B-6087482, or the like can be used.

As described above, according to the shield molding blank 1 of the present embodiment, air filled in the air gap 4 formed between two metal plates 2 and 3 exhibits resistance, and transmission of heat and sound is inhibited. Thus, the shield S having improved shielding characteristics can be molded.

Moreover, in producing such a shield molding blank 1, the metal plates 2, 3 formed in the wavy shapes by two sets of wavy shape-forming rolls 201 202 configured so that the gear rolls to be paired are synchronously driven at the same rotational speed are punched in the staggered blank layout. Thus, the shield molding blank 1 can be produced with a satisfactory yield by reducing the scraps.

As described above, the present invention is described with reference to the preferable embodiments, but the present invention is not limited only to the embodiments described above, and the present invention can be obviously practiced with various modifications within the scope of the present invention.

The entire contents of the documents described in the description concerning the present application and the description of the Japanese application serving as a basis of claiming the priority concerning the present application to the Paris Convention are incorporated by reference herein.

### INDUSTRIAL APPLICABILITY

The present invention can be widely used as a technology to produce a shield which covers a heat and noise generator such as an exhaust manifold and a turbocharger attached to an engine.

### EXPLANATION OF NUMERICAL SYMBOLS

1 Blank

2, 3 Metal plate

4 Air gap

S Shield

1. A shield molding blank, comprising
an uneven structure in which an air gap is formed between two metal plates stacked and formed in overlapping wavy shapes comprising recesses and projections that are periodically continuous in two directions orthogonal to each other,
wherein the shield molding blank is cut into a desired expanded shape and has peripheral edges folded.

2. The shield molding blank according to claim 1, wherein the uneven structure comprises a top portion or a bottom portion of the recesses and the projections, and the recesses and projections are formed symmetrically to a surface orthogonal to a direction in which the recesses and the projections are periodically continuous.

3. The shield molding blank according to claim 1, wherein the metal plate stacked on a back surface side is thinner-walled, as compared to the metal plate stacked on a front surface side, and the shield molding blank has the peripheral edges folded onto the back surface side.

4. A shield, formed by processing the shield molding blank according to claim 1.

5. The shield molding blank according to claim 2, wherein the metal plate stacked on a back surface side is thinner-walled, as compared to the metal plate stacked on a front surface side, and the shield molding blank has the peripheral edges folded onto the back surface side.

6. A shield, formed by processing the shield molding blank according to claim 2.

7. A shield, formed by processing the shield molding blank according to claim 3.

8. A shield, formed by processing the shield molding blank according to claim 5.
